(19) United States
(12) Patent Application Publication
(10) Pub. No.: US 2022/0221753 A1
(43) Pub. Date: Jul. 14, 2022

(54) GLAZING HAVING A VARIABLE SWITCHABLE FILM

(71) Applicant: CENTRAL GLASS COMPANY, LIMITED, Ube-shi, Yamaguchi (JP)

(72) Inventors: Adil Mahmood Malik, Grevenmacher (LU); Wladislaw Bronstein, Grevenmacher (LU)

(73) Assignee: CENTRAL GLASS COMPANY, LIMITED, Ube-shi, Yamaguchi (JP)

(21) Appl. No.: 17/605,776

(22) PCT Filed: Jun. 12, 2020
(86) PCT No.: PCT/EP2020/066369

§ 371 Date: Oct. 22, 2021

Related U.S. Application Data
(60) Provisional application No. 62/860,442, filed on Jun. 12, 2019.

(51) Int. Cl. G02F 1/1333; G02F 1/1334; G02F 1/1676; B60J 1/00; B32B 3/26; B32B 17/10

(52) U.S. Cl. CPC G02F 1/133371; G02F 1/13345; G02F 1/1676; B60J 1/001; B32B 2605/08; B32B 17/10036; B32B 17/10504; B32B 17/10532; B32B 17/10779; B32B 3/263

(57) ABSTRACT

A glazing capable of gradient opacity includes a first glass substrate (110) and a second glass substrate (110), a first interlayer (214) and a second interlayer (116), provided between the first glass substrate and the second glass substrate, and a switchable film (130) provided between the first interlayer and the second interlayer. The switchable film includes a switchable material layer (220) having first and second surfaces (SF₁, SF₂) opposite each other, wherein the switchable material layer (220) has an uneven effective thickness. A first conductive layer (226) and a second conductive layer (128) sandwich the switchable material layer (220), and a first polymer film (222) and a second polymer film (124) sandwich the switchable material layer and the first and second conductive layers.

### CROSS REFERENCE TO RELATED APPLICATION

This application claims priority to U.S. provisional patent application Ser. No. 62/860,442, filed Jun. 12, 2019, entitled “GLAZING HAVING A VARIABLE SWITCHABLE FILM,” the entire contents of which are incorporated herein by reference in their entirety.

### TECHNICAL FIELD

The present disclosure is generally related to a switchable film which may have a gradient opaque to transparent effect.

### BACKGROUND

Switchable films in glass constructions may be provided for various purposes, including architectural and vehicle windows. Switchable films may include those based on liquid crystal constructions. A switchable film may be selectively changed from an opaque or dark state to a transparent, or clear, state by the application of an electric field to the film. The electrical connection may be formed within the glass construction to control the switchable material. When an electric field is activated, the switchable material may transfer from an opaque state to a transparent state or vice versa.

Switchable materials may include polymer dispersed liquid crystal (PDLC) and polymer network liquid crystal (PNLC) constructions. PDLC materials are formed by liquid crystals dispersed throughout a liquid polymer matrix. As the polymer matrix solidifies, the liquid crystals form droplets. The random orientation of liquid crystal droplets results in the opaque, milky appearance of the PDLC in an OFF state. When an electrical current is applied to the PDLC, the liquid crystals may align parallel to the direction of the electric field. The parallel orientation allows for light to pass through, and in an ON state, PDLC is transparent relative to the OFF state. PNLC may also provide a film that may selectively switch between opaque and transparent states. PNLC films may have a higher ratio of liquid crystal to polymer and require a lower driving voltage than a PDLC. PDLC and PNLC films may also be configured to have a reverse alignment where, in a default OFF state, the PDLC or PNLC is transparent, and in an ON state with an electric voltage applied, the PDLC or PNLC is opaque.

A switchable film known in the art may be homogeneously changed from opaque to transparent in an ON state. However, it may be desirable in some eases to provide a non-homogeneous transition from opaque to transparent across an entire liquid crystal film. For example, various patterned appearances may provide an aesthetically desirable appearance. Further, it is desirable to provide a non-segmented switchable film which may provide a gradient opacity.

### SUMMARY OF THE DISCLOSURES

Disclosed herein is a glazing comprising: a first glass substrate and a second glass substrate; a first interlayer and a second interlayer, provided between the first glass substrate and the second glass substrate; and a switchable film provided between the first interlayer and the second interlayer, the switchable film comprising: a switchable material layer having first and second surfaces opposite each other, the first and second surfaces arranged as to vary a thickness between the first and second surfaces in association with a position in the surfaces; a first conductive layer and a second conductive layer, sandwiching the switchable material layer; and a first polymer film and a second polymer film, sandwiching the switchable material layer and the first and second conductive layers.

In certain embodiments, the switchable material layer may include a polymer dispersed liquid crystal or a polymer network liquid crystal and may have a minimum thickness greater than or equal to 5 μm, preferably greater than or equal to 10 μm, and more preferably greater than or equal to 20 μm and/or a maximum a maximum thickness equal to or less than 60 μm, preferably less than or equal to 50 μm, and more preferably less than or equal to 40 μm. The thickness of the switchable material layer in this specification is defined by a distance between the first and second surfaces of the switchable material layer. In certain embodiments, the difference between the minimum and maximum thicknesses is at least 10 μm, preferably at least 20 μm, and more preferably at least 25 μm. In some embodiments, the switchable material layer may include a suspended particle device (SPD), which may include a dispersal of light-controlling microparticles.

The shape of the switchable material layer may be modified according to usage or purpose of the glazing. In certain embodiments, the switchable material layer may have a shape of, e.g., a wedge, a single or double side curving shape, or a cross-sectionally stepwise shape.

To activate the switchable film, a power source may be provided to an electric wire connected to the first and second conductive layers. In certain embodiments, a voltage applied to the switchable film may be from 20 to 120 volts, preferably from 25 to 70 volts, and more preferably from 28 to 50 volts.

In another aspect of the disclosure, the switchable material layer may include droplets which may vary an effective thickness between the first and second surfaces of the switchable material layer.

Aspects and preferred and optional aspects of our proposals herein are also set out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a glazing construction having a switchable film in a wedge shape, according to an exemplary aspect of the present disclosure;

FIG. 2 illustrates a glazing construction having a switchable film including liquid crystal droplets, according to another exemplary aspect of the present disclosure;

FIG. 3 illustrates a glazing construction having a switchable film with a switchable material layer having a combination of a flat portion and a wedge portion, according to yet another exemplary aspect of the present disclosure;

FIG. 4 illustrates a glazing construction having a switchable film with a switchable material layer in a curving shape, according to yet another exemplary aspect of the present disclosure;

FIG. 5 illustrates a glazing construction having a switchable film with a switchable material layer in another curving shape, according to yet another exemplary aspect of the present disclosure;

FIG. 6 illustrates a glazing construction having a switchable film with a switchable material layer in a cross-sectionally stepwise shape, according to an exemplary aspect of the present disclosure; and

FIG. 7 illustrates a glazing construction having a switchable film with a switchable material layer in another cross-sectionally stepwise shape, according to an exemplary aspect of the present disclosure.

### DETAILED DESCRIPTION

In the following description, for purposes of explanation, specific details are set forth in order to promote a thorough understanding of one or more aspects of the disclosure. It may be evident in some or all instances, however, that any aspects described below can be practiced without adopting the specific design details described below. This disclosure relates generally to a switchable film having an inhomogeneous opacity under an applied voltage. The descriptions herein may refer to a particular embodiment, however, the application may not be limited to a particular switchable material.

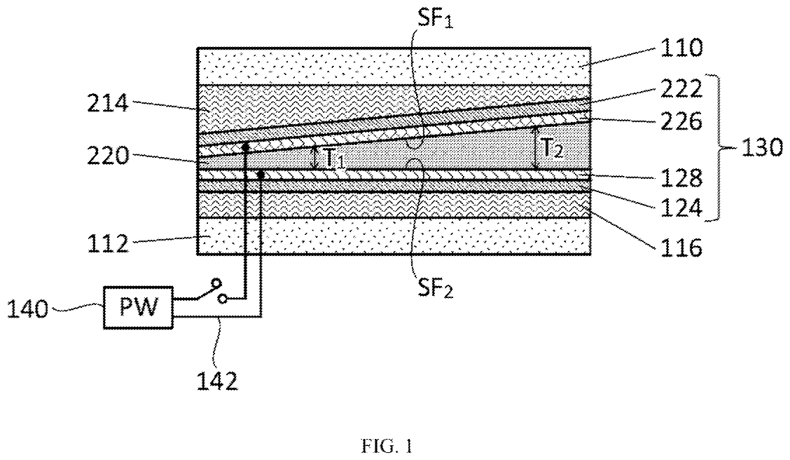

FIG. 1 shows a glazing with a switchable film in a wedge shape. The glazing may include first and second substrates 110,112 positioned on opposite sides of a switchable film 130. The switchable film 130 may include a switchable material layer 220, first and second conductive layers 226,128, and outer polymer films 222,124. In some embodiments disclosed herein, the switchable material layer 220 may have a wedge shape, as shown in FIG. 1; here the thickness increases gradually in one direction across the layer.

The first and second substrates 110,112 may be glass substrates or glass panes, typically made of, e.g., soda-lime glass substrate/pane manufactured by a float method known in the art which may be prepared and cut to be in a desired size and shape for production. The glass substrates 110,112 may be bent to a desired shape using any suitable glass bending process. The glass substrates 110,120 may have a thickness of e.g. about 0.05 mm to 10.0 mm, preferably from about 0.5 mm to 3.0 mm, more preferably from about 1.0 mm to 2.6 mm. To assemble a vehicle glazing, a pair of glass substrates, namely a first glass substrate and a second glass substrate, may be used.

A first interlayer 214 may be positioned between the first glass substrate 110 and the switchable film 130, whereas a second interlayer 116 may be positioned between the second glass substrate 112 and the switchable film 130. The interlayers 214,116 may be of polymer adhesive, such as polyvinyl butyral (PVB), ethylene vinyl acetate (EVA), or ionomers.

The switchable film 130 may include various layers, including outer polymer films 222,124, the switchable material layer 220, and transparent first and second conductive layers 226,128 provided between the outer polymer films 222,124 and the switchable material layer 220. Conventional transparent conductive layers are parallel to each other, such that the switchable material layer has two opposite, parallel surfaces. In certain embodiments of the present disclosure, the first and second conductive layers 226,128, and the outer polymer films 222,124 may be non-parallel. The polymer film 222 and the conductive layer 226 may be at an angle relative to the outer glazing surfaces as the polymer film 222 and the conductive layer 226 may be positioned against a wedge shaped switchable layer 130. In certain embodiments, the polymer film 124 and the conductive layer 128 may be at an angle to the outer glazing surfaces. That is, thickness change over the switchable material layer herein may be accompanied by a change of spacing of its surface from the surface of the first substrate, or from the surface of the second substrate, or from the surfaces of both substrates.

The outer polymer films 222,124 may be formed of any suitable polyolefin films such as, e.g., polyethylene terephthalate (PET) film, or acrylic resin films. The outer polymer films 222,124 may serve as base material films for forming thin coatings of the conductive materials and as protection films for protecting conductive and switchable materials inside the switchable film. They may be of uniform thickness. The first and second conductive layers 226,128 may be formed of, e.g., any suitable transparent metal oxide films, such as indium tin oxide, titanium dioxide, and zinc oxide. The first and second conductive layers 226,128 may serve as electrodes for turning on and off the switching material layer 220. They may be of uniform thickness.

The switchable film 130 may function as a device to control the transparency of the glazing according to a supply voltage fed from a power source 140. The switchable film 130 may preferably include, but is not limited to, a polymer dispersed liquid crystal (PDLC), a polymer network liquid crystal (PNLC), or a suspended particle devices (SPD) film. A PDLC or PNLC film may preferably provide a milky, opaque surface in an OFF state.

The power source 140 may provide an alternating current voltage through wiring 142 connected to the conductive layers 226,128. The voltage applied may be in any suitable waveform. For example, waveforms may include a sinusoidal, square, triangle, trapezoidal or combinations thereof with any suitable operational parameters, such as effective voltage, V_{RMS}, and frequency. With this power supply connection, the switchable material layer 220 may be switched between ON and OFF states. Particularly, a PDLC film may be opaque in an OFF state and transparent in an ON state. As discussed herein, some light may transmit through a film in an “opaque” state while a “transparent” film has a higher visible light transmittance than the “opaque” film. In some embodiments, the switchable film may be opaque in an ON state and transparent in an OFF state.

In an ON state, the amount of light transmitted through the switchable film may depend in part on the electric voltage applied thereto, as a higher voltage may provide a more transparent ON state. In a typical switchable film, which may include parallel conductive layers, the ON and OFF states may be homogeneous across the film. It may be desirable to provide a switchable film which may be variably affected by a given voltage. Particularly, a switchable film with a wedge shaped switchable material layer may provide a gradient of opaque to transparent film under a stable applied voltage. As such, a gradient or variable transparency may be achieved under a single power supply. Further, a switchable film may have a variable appearance in an OFF state.

Variable switchable films may be used in any suitable glazing, including architectural and automotive applications. An automotive glazing may include windshields, sunroofs, back windows, side windows, and partitions. Particularly, the present glazing may be used as a shade band in a windshield.

As disclosed herein, a graduated optical appearance may be formed in a switchable film by suitable means such that the switchable films may be powered by the single power source 140 with a single electrical connection (which may include two busbars) to provide a variable transparency and/or haze in the switchable film 130 in an ON and/or OFF state.

Where the switchable material layer 220 is formed between the conductive layers 226,128, the thickness of the switchable material layer 220 may be defined as an effective thickness. In some embodiments, actual thickness may correlate to effective thickness. For example, where liquid crystal droplets are evenly dispersed within a switchable material layer 220, the actual thickness of the switchable material layer 220 may correlate to the effective thickness of the switchable material layer 220. The increased thickness may include relatively more liquid crystals than an area of less thickness which has a similar density of liquid crystal droplets. Thus, where an effective thickness is high, a switchable film may be relatively more opaque than a low effective thickness. Non-liquid crystal materials, such as SPD, may also have an actual thickness which corresponds to an effective thickness. The effective thickness of a switchable material layer may further be affected by the number of liquid crystal droplets or microparticles in a switchable material layer. Even where a switchable material layer has a uniform actual thickness, the effective thickness of the switchable material layer 220 may be varied. For example, the density of liquid crystal droplets may vary within the switchable material layer 220 having an even actual thickness, providing varied effective thickness. In a switchable material layer having a uniform thickness, an area having relatively more liquid crystal droplets may be more opaque than an area of the switchable material layer having the same thickness and relatively fewer liquid crystal droplets. As described herein, with respect to a switchable material layer having a uniform thickness, high density areas of liquid crystal droplets refers to areas of the even layer thickness having more liquid crystal droplets than a low density portion of the switchable material layer.

In this disclosure, the switchable film 130 having a variable optical appearance may be formed with the switchable material layer 220 having a varied thickness. As illustrated in FIG. 1, the switchable material layer 220 may have different thicknesses T₁, T₂. A thick liquid crystal layer may appear more opaque than a relatively thinner liquid crystal layer in both an OFF and an ON state. For example, a relatively thick area of liquid crystal materials may have more liquid crystal droplets than a thinner area of the materials, and the larger number of liquid crystal droplets may deflect more light, providing a relatively more opaque area. The variation in gradient across the switchable film may be the same or different between the ON and OFF states. Even where an electric voltage applied to the switchable layer is stable, such that a given voltage is applied to the entire film, an uneven switchable layer, i.e., having a varied thickness across the layer, may provide an uneven electric field across the switchable layer.

The switchable material layer 220 may be formed between the conductive layers 226,128 wherein the distance between the conductive layers is the thickness of the switchable material layer 220. The switchable material layer 220 has first and second surfaces SF₁, SF₂ defining a thickness between the first and second surfaces SF₁, SF₂. In some preferable embodiments, the first and second surfaces SF₁, SF₂ of the switchable material layer 220 may not be parallel. Non-parallel surfaces SF₁, SF₂ may provide a switchable material layer 220 with an uneven thickness. For example, a switchable film may be formed having a switchable material layer 220 that has a wedge shape. Where the switchable material layer is thicker, a higher resistance may be formed, and the voltage applied may have less switching effect on the film. Where the switchable material layer provides a relatively smaller distance between the conductive layers, the resistance may be lower and the same voltage may provide a relatively higher switching effect. Thus, the distance between conductive layers may have a local impact on the switching function of a liquid crystal switchable layer 220 therebetween.

The switchable film may have any variable pattern. For example, the film may have a gradient across a film, or a gradient from an edge or edges of the film toward the film center. Further, the thickness variation may be by step change or by gradual or continuous change to the film opacity and or transparency. Although embodiments may be described herein as having a gradient, it may be understood that the switchable film may have any suitable pattern. A glazing with such a switchable film may have a patterned, aesthetically desirable appearance. Some particular embodiments may provide a glazing structured with a non-segmented switchable film which may have a smooth gradient opacity.

In this disclosure, a switchable film, particularly a liquid crystal switchable film, having a non-uniform thickness may have a switchable material layer with a minimum actual thickness of at least 5 μm, preferably at least 10 μm, and more preferably at least 20 μm. The switchable film may have a switchable material layer with a maximum actual thickness equal to or less than 60 μm, preferably equal to or less than 50 μm, and more preferably equal to or less than 40 μm. The switchable material layer may have a difference between a minimum actual thickness and a maximum actual thickness of at least 10 μm, preferably at least 20 μm, and more preferably at least 25 μm. An SPD switchable material layer may have a minimum actual thickness greater than or equal to 40 μm, preferably greater than or equal to 60 μm, and more preferably greater than or equal to 80 μm. An SPD switchable material layer may have a maximum actual thickness of less than or equal to 180 μm, preferably less than or equal to 160 μm, and more preferably less than or equal to 140 μm. The SPD switchable material layer may have a difference between a minimum actual thickness and a maximum actual thickness of at least 20 μm, preferably at least 40 μm, and more preferably at least 60 μm.

Where a switchable film has a difference between a minimum actual thickness and a maximum actual thickness of less than or equal to 100 μm, a lamination incorporating the switchable film does not necessarily require lamination materials to compensate for the change in switchable film thickness. For example, a switchable film having a switchable material layer thickness variation of 25 μm may be laminated between two interlayers, each having uniform thickness, and two glass substrates, each having uniform thickness. Where a switchable film has a switchable material layer with a difference between a minimum actual thickness and a maximum actual thickness of greater than 100 μm, typically a lamination of such a switchable film may include an interlayer having a changing thickness to compensate for or complement such a change in the film thickness. The interlayer may have a changing thickness which compensates for or complements a change in switchable material layer thickness. For example, where a switchable material layer has a wedge-shaped change in thickness, the interlayer may have a wedge-shaped change in thickness opposite to that of the switchable material layer.

The switching effect may comprise a change in light transmittance and/or haze. For example, peak transparency may be reached at a different voltage than a peak haze. As described herein, peak transparency is defined as the visible light transparency of a switchable film at which additional voltage increases do not increase the switchable film visible light transparency. Peak haze is defined as the haze value of a switchable film at which additional voltage increases do not decrease the haze of the switchable film. Visible light transparency may be measured according to ISO 13837:2006. Haze may be measured by any suitable machinery, including “Haze-Gard I” available from BYK . . . Gardner, and by ASTM D 1003:2000. Where a switchable layer has a non-uniform thickness, the peak transmittance and peak haze may be reached at different points across the switchable layer. For example, a thin part of the switchable layer may reach peak transparency and peak haze before a thick part of the switchable layer. A user may apply a voltage high enough that a majority or entirety of a switchable film is at peak transparency and/or peak haze.

The switchable film may respond differently under different voltages. For example, under a low voltage the switchable film may not reach peak transparency and/or haze. As higher voltages are applied to the film, the transparency and/or haze may improve towards peak values. In some embodiments, the voltage applied to the film may be variable, however, only a given voltage may be applied at a time. A user may be able to select a particular voltage to apply to the film for a desired effect. For example, the user may choose from settings, e.g. low, medium, high, which may apply different voltages to a switchable film. The possible voltage settings may include at least one voltage at which the switchable film has an inhomogeneous transparency and/or haze. Further, the settings may include a voltage at which the film is at peak transparency and/or peak haze across a majority of the film. In embodiments, the effective voltage applied to the switchable film is from 20 to 120 volts, preferably from 25 to 70 volts, and more preferably from 28 to 50 volts. Preferably, at some applied voltage, the switchable film may have a range of visible light transparency of at least 10%, more preferably at least 20%, where the visible light transparency range is calculated as a difference between a maximum transparency percentage and a minimum transparency percentage in the switchable film at the applied voltage.

The switchable film having a non-uniform switchable layer may be laminated in a glazing. The switchable film may include a switchable layer core surrounded by conductive layers and further surrounded by polymer film layers. Particularly, the conductive layers may be coated on the polymer film layers. The switchable film may be positioned between two interlayers, which may include PVB. The interlayers and film may further be positioned between two substrates, which may include glass sheets. Lamination of the glazing may include conventional processes, including autoclaving.

In some embodiments, the switchable material may be a suspended particle device (SPD). An SPD layer which is provided as a non-even layer, such as in a wedge shape, may provide a non-even color appearance. Thin areas of SPD may have a lighter color appearance than thicker areas of SPD. As such, in an OFF state, the SPD may provide a variable color appearance. Further, there may also be a variable color appearance in an ON state. When voltage is applied to an SPD film, the transition to the ON state may be gradual, as a thin area of an SPD layer may become transparent more rapidly than a thick area of SPD. Where SPD is the switchable material, a change in color may be more visible in an OFF state than in an ON state.

A wedge shaped switchable material layer may be formed by any suitable means, including roll-to-roll manufacturing. For example, in roll-to-roll lamination, two outer films may be rolled together with a switchable material positioned therebetween. Two rolls having outer polymer films coated with conductive layers may be rolled together with a switchable material filling the space between the films. Spacers may be used in the switchable layer to maintain the film thickness. Spacers having a varied size may be utilized to form the variable or graduated change in switchable material thickness. The switchable material may then be cured.

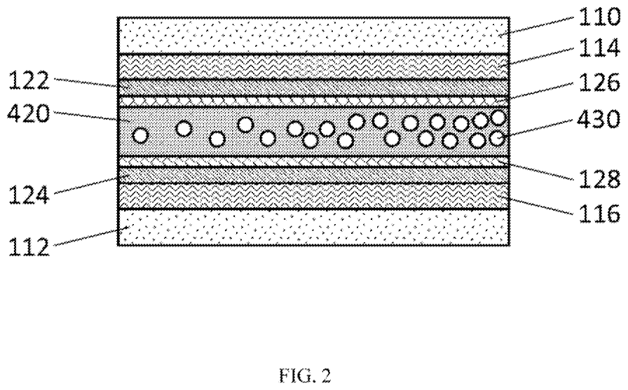

In further embodiments, the variable switchable effect may be formed by a variable distribution of liquid crystal droplets 430 in a switchable layer 420, as shown in FIG. 2. A switchable film having liquid crystals may include PDLC or PNLC. For example, in a PDLC film liquid crystal droplets 430 may be provided in a polymer matrix. The distribution of liquid crystal droplets in the switchable film may affect the opacity or haze of the film. For example, where a relatively lower density of liquid crystal droplets is provided in a switchable layer, the layer may have a less opaque appearance with less haze, as less light is scattered by the liquid crystal droplets in both the ON and OFF states. A single electrical connection may be used to provide power to the film; however, the variable density of liquid crystal droplets may provide a variable ON state, such that areas with relatively more liquid crystal droplets may be relatively less transparent and hazier in an ON and/or OFF state. As described herein, areas of the film having a greater amount or density of liquid crystal droplets may have a larger effective thickness than an area of the switchable film having a relatively lower density of liquid crystal droplets.

A PDLC switchable material may include droplets of liquid crystals dispersed through the matrix of a transparent solid which forms a composite material. Liquid crystals may be dispersed in the matrix material in a liquid form, and then during curing of the materials, the liquid crystals may form droplets within the matrix. The liquid crystal material and the matrix may be selected to have matched indices of refraction. The droplets of liquid crystal may be e.g. about 0.2 micrometer (μm) or greater in size. They may be also of irregular size and shape distribution, and may be dispersed throughout the solid in a somewhat irregular distribution.

The liquid crystal droplets may have a non-uniform density across a switchable film. The effective thickness between the first and second surfaces may depend on a density of the liquid crystal droplets in a switchable material layer having an even thickness. Where the liquid crystal droplets are dispersed in the liquid crystal matrix in a high density, the material may have a relatively low transparency, and where the liquid crystal droplets are dispersed in the liquid crystal matrix in a low density, the material may have a high transparency in comparison with the liquid crystal droplet high density area.

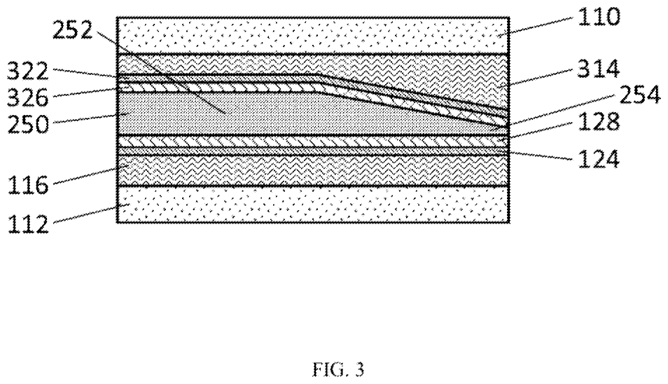

FIGS. 3 to 7 show other possible shapes of the switchable films according to this disclosure. FIG. 3 illustrates a glazing having a switchable material layer 250 having a flat portion 252 with a uniform thickness and a wedge-shaped portion 254 having a changing thickness. As shown, the wedge-shaped portion 254 may have the same thickness as that of the flat portion 252 where the flat portion 252 meets the wedge-shaped portion 254. In some embodiments, as shown in FIG. 3, the wedge-shaped portion 254 may decrease in size moving away from the flat portion 252, while in some other embodiments, the wedge-shaped portion may increase in size moving away from the flat portion. The switchable material layer 250 may be formed with first and second conductive layers 326,128 and first and second outer polymer layers 322,124 for covering the switchable material layer 250. This partially wedge shaped switchable film may be sandwiched by the first and second glass substrates 110,112 and by a first interlayer 314 and a second interlayer 116. The glazing with this switchable film may provide a non-uniform, aesthetically desirable appearance.

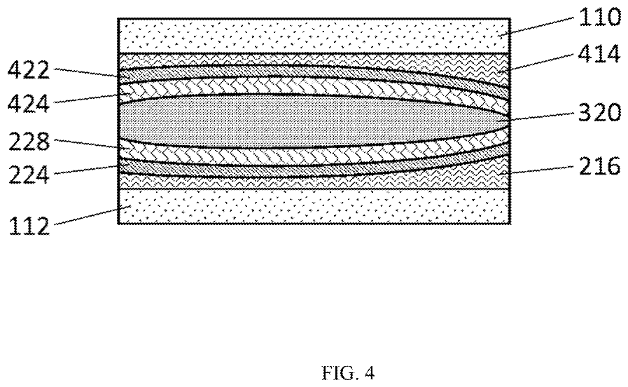

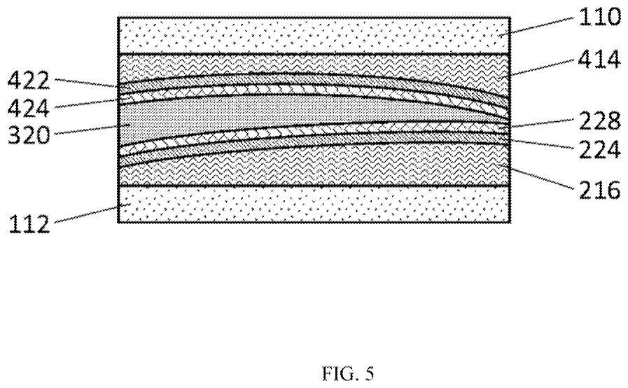

FIGS. 4 and 5 show further structures of switchable films having curved shapes according to farther embodiments of the present disclosure. The glazing shown in FIG. 4 includes a double-sided curved switchable material layer 320 positioned between first and second conductive layers 424,228 and outer polymer layers 422,224. The surfaces of the switchable material layer 320 may curve in convex shapes, with respect to the switchable material layer 320, so as to vary the thickness of the switchable material layer 320 with a thickest portion of the switchable material layer 320 being in a middle portion of the layer 320. In some embodiments, the surfaces of the switchable material layer 320 may have concave shapes, with respect to the switchable material layer 320. The conductive layers 424,228 and the outer polymer layers 422,224 may have a uniform thickness across the switchable film and may be positioned along the switchable material layer's curved shape. The switchable film may be laminated between first and second interlayers 414,216 and first and second glass substrates 110,112. The glazing shown in FIG. 5 includes a switchable material layer 320 with a curved shape between first and second conductive layers 424,228 and outer polymer layers 422,224. The surfaces of the switchable material layer 320 are curving in convex and concave shapes, with respect to the switchable material layer 320, as to vary the thickness of the switchable material layer 320. The conductive layers 424,228 and the outer polymer layers 422,224 may have a uniform thickness across the switchable film and may be shaped along the switchable material layer 320 surfaces. The switchable film may be laminated between first and second interlayers 414,216 and first and second glass substrates 110,112. A glazing with a curved switchable film may provide a non-uniform, aesthetically desirable appearance.

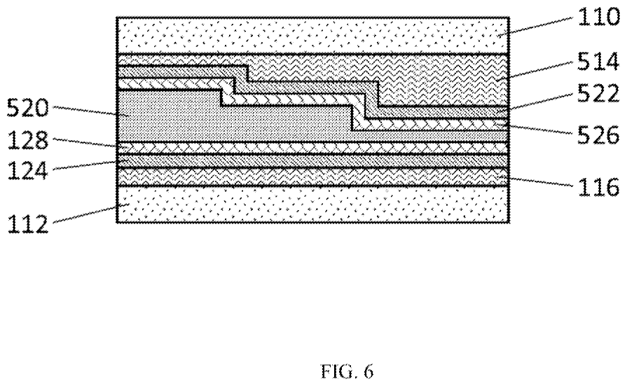

A further glazing shown in FIG. 6 may have a switchable material layer 520 having a cross-sectionally stepwise shape positioned between first and second conductive layers 526,128 and outer polymer layers 522,124. The conductive layers 526,128 and the outer polymer layers 522,124 may have a uniform thickness across the switchable film and may have the same shape as a surface of the switchable material layer 520. Such a switchable film may be laminated between first and second interlayers 514,116 and first and second glass substrates 110,112. With such thickness differences in the switchable material layer 520, the voltage change between the first and second conductive layers may provide a gradient effect in opacity.

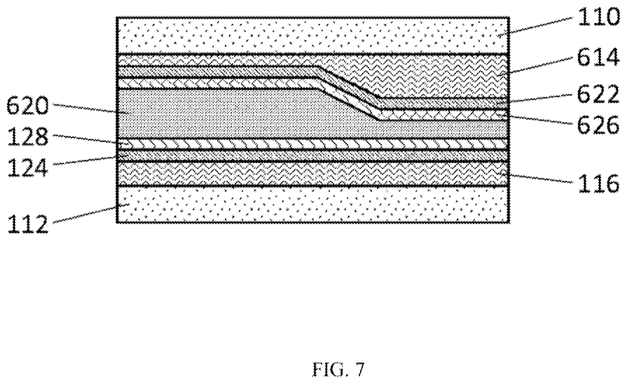

A glazing shown in FIG. 7 has a structure modified from the structure shown in FIG. 6. The glazing has a switchable material layer 620 having a cross-sectionally stepwise shape sandwiched by first and second conductive layers 626,128 and outer polymer layers 622,124. The switchable material layer 620 may have a cross-section showing a portion with an inclined slope. The conductive layers 626,128 and the outer polymer layers 622,124 may each have a uniform thickness across the switchable film and may be formed with the same shape as the switchable material layer 620 surfaces. The switchable film may be laminated between first and second interlayers 614,116 and first and second glass substrates 110,112. The glazing with this stepwise shaped switchable film may provide a desirable change in transparency in a laminated glazing.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. For example, PDLC, and PNLC, and SPD are described in the above description, however, the present disclosure is not limited to those switchable materials. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A glazing comprising:
a first glass substrate and a second glass substrate;
a first interlayer and a second interlayer, wherein the first interlayer and the second interlayer are positioned between the first glass substrate and the second glass substrate; and
a switchable film provided between the first interlayer and the second interlayer, the switchable film comprising:
a switchable material layer having first and second surfaces opposite each other, wherein the switchable material layer varies in effective thickness;
a first conductive layer and a second conductive layer, wherein the switchable material layer is positioned between the first conductive layer and the second conductive layer; and
a first polymer film and a second polymer film, wherein the switchable material layer and the first and second conductive layers are positioned between the first polymer film and the second polymer film.

2. The glazing according to claim 1, wherein the switchable material layer varies in actual thickness.

3. The glazing according to claim 1, wherein the switchable material layer comprises a polymer dispersed liquid crystal.

4. The glazing according to claim 1, wherein the switchable material layer comprises a polymer network liquid crystal.

5. The glazing according to claim 1, wherein the switchable material layer comprises a suspended particle device.

6. The glazing according to claim 2, wherein the switchable material layer has a minimum actual thickness greater than or equal to 5 μm.

7. (canceled)

8. (canceled)

9. The glazing according to claim 2, wherein the switchable material layer has a maximum actual thickness less than or equal to 60 μm.

10. (canceled)

11. (canceled)

12. The glazing according to claim 2, wherein the switchable material layer is wedge shaped.

13. The glazing according to claim 2, wherein the switchable material layer includes a flat portion and a wedge shaped portion.

14. The glazing according to claim 2, wherein at least a part of the switchable material layer has a curved surface.

15. The glazing according to claim 2, wherein the switchable material layer has a cross-sectionally stepwise shape.

16. The glazing according to claim 1, further comprising an electrical connection to a power source, wherein the power source provides a voltage to the switchable film.

17. The glazing according to claim 16, wherein the power source provides from 20 to 120 volts effective voltage to the switchable film.

18. (canceled)

19. (canceled)

20. The glazing according to claim 1, wherein the glazing is an automotive glazing.

21. The glazing according to claim 2, wherein the switchable material layer has a minimum actual thickness and a maximum actual thickness, wherein a difference between the minimum and maximum actual thicknesses is more than 10 μm.

22. (canceled)

23. (canceled)

24. The glazing according to claim 1, wherein the switchable material layer comprises a liquid crystal material wherein the liquid crystal material comprises liquid crystal droplets, wherein the liquid crystal droplets have a non-uniform density, and wherein the effective thickness of the switchable material layer depends on the density of the liquid crystal droplets.

25. The glazing according to claim 24, wherein the liquid crystal droplets are distributed in the switchable material layer to provide a gradient change in density within the switchable material layer.

26. The glazing according to claim 1, wherein the switchable material layer comprises suspended particles for a suspended particle device, wherein the suspended particles have a non-uniform density, and wherein the effective thickness of the switchable material layer depends on the density of the suspended particles.

27. A switchable film, comprising:
a switchable material layer having first and second surfaces opposite each other, wherein the switchable material layer has an uneven effective thickness;
a first conductive layer and a second conductive layer, wherein the switchable material layer is positioned between the first and second conductive layers; and
a first polymer film and a second polymer film, wherein the switchable material layer and the first and second conductive layers are positioned between the first and second polymer films.
